(19) United States
(12) Patent Application Publication
(10) Pub. No.: US 2018/0129468 A1
(43) Pub. Date: May 10, 2018

(54) WIRELESS EXPANDING SYSTEM AND WIRELESS EXPANDING METHOD

(71) Applicants: Inventec (Pudong) Technology Corporation, Shanghai (CN); INVENTEC CORPORATION, TAIPEI CITY (TW)

(72) Inventors: Feng-Ku WANG, TAIPEI CITY (TW); Lung-Hsun SONG, TAIPEI CITY (TW); Chun-Chi LIN, TAIPEI CITY (TW); Chia-Cheng SHIH, TAIPEI CITY (TW)

(21) Appl. No.: 15/479,255

(22) Filed: Apr. 4, 2017

(30) Foreign Application Priority Data
Nov. 10, 2016 (CN) 201610987954.5

(51) Int. Cl. G06F 3/14; G06F 3/03; G09G 5/12

(52) U.S. Cl. CPC G06F 3/1454; G06F 3/03; G09G 2340/145; G06F 2203/0384; G09G 2370/16; G09G 5/12

(57) ABSTRACT

A wireless expanding system includes an electronic device and a wireless expanding interface, and the wireless expanding interface is connected to the electronic device. The electronic device is configured to execute an operational procedure, and to generate an operational signal according to the operational procedure. The wireless expanding interface is configured to transmit the operational signal to a function expanding device. The function expanding device includes a displayer. When the displayer receives the operational signal via the wireless expanding interface, the displayer is configured to display an operational interface of the operational procedure.

### RELATED APPLICATIONS

This application claims priority to Chinese Application Serial Number 201610987954.5, filed Nov. 10, 2016, which is herein incorporated by reference.

### BACKGROUND

### Field of Invention

The present disclosure relates to an expanding system and an expanding method. More particularly, the present disclosure relates to a wireless expanding system and wireless expanding system.

### Description of Related Art

With the rapid development of mobile technology, a mobile device is widely applied in human life and playing an increasingly important role. Currently, most manufacturers make great efforts to decrease area of their mobile devices, so as to enhance portability of the mobile devices to strengthen competitiveness of their mobile devices. However, quality of user experience may be reduced while excessively decreasing the area of the mobile devices. For example, although the portability of the mobile devices can effectively enhanced by decreasing an operational interface of the mobile devices (such as, a displayer and an input device), this may result that a user is unable to comfortably look up data or input data, so that the quality of user experience is reduced.

Accordingly, a significant challenge is related to ways in which to effectively remain the portability of the mobile devices while at the same time enhancing the quality of user experience associated with designing wireless expanding systems and wireless expanding methods.

### SUMMARY

An aspect of the present disclosure is directed to a wireless expanding system. The wireless expanding system includes an electronic device and a wireless expanding interface, and the wireless expanding interface is connected to the electronic device. The electronic device is configured to execute an operational procedure, and to generate an operational signal according to the operational procedure. The wireless expanding interface is configured to transmit the operational signal to a function expanding device. The function expanding device includes a displayer. When the displayer receives the operational signal via the wireless expanding interface, the displayer is configured to display an operational interface of the operational procedure.

Another aspect of the present disclosure is directed to a wireless expanding method. The wireless expanding method includes operations as follows: executing an operational procedure, and generating an operational signal according to the operational procedure via an electronic device; transmitting the operational signal to a function expanding device via a wireless expanding interface, wherein the function expanding device comprises a displayer; and when the displayer receives the operational signal via the wireless expanding interface, displaying an operational interface of the operational procedure via the displayer.

It is to be understood that the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a block schematic diagram of a wireless expanding system according to embodiments of the present disclosure; and

FIG. 2 is a flow chart of a wireless expanding method according to embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intend ed to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or otters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

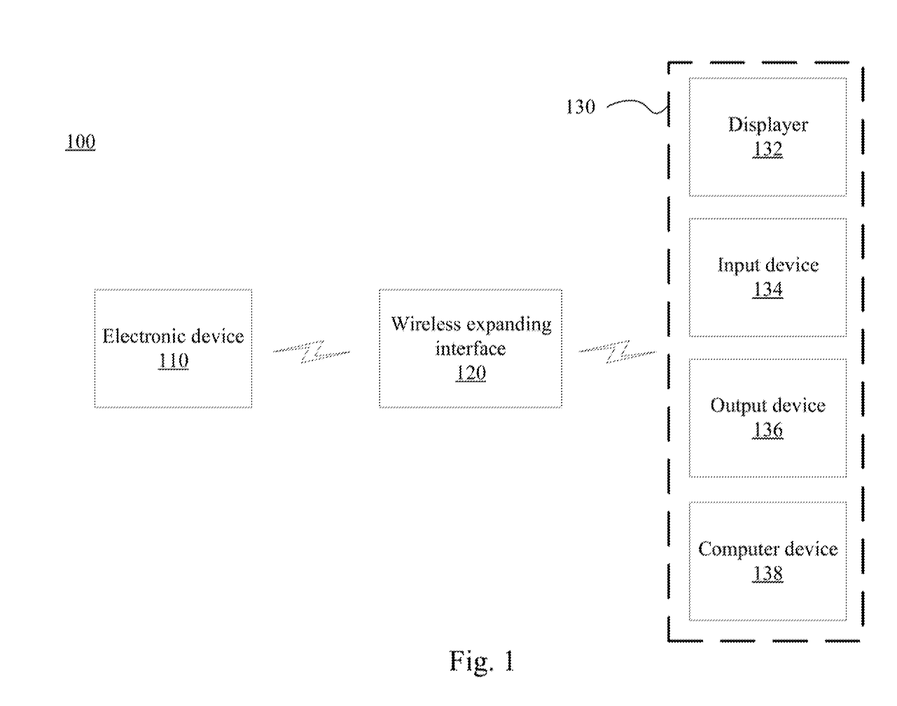

FIG. 1 is a block schematic diagram of a wireless expanding system 100 according to embodiments of the present disclosure. As shown in FIG. 1, the wireless expanding system 100 includes an electronic device 110 and a wireless expanding interface 120 and the wireless expanding interface 120 is connected to the electronic device 110. For example, the electronic device 110 can be a smart device, a tablet device or any other device which can be configured to execute data process; the wireless expanding interface 120 can be any access interface which can be configured to execute wireless access (such as, Wi-Fi or Miracast).

The electronic device 110 is configured to execute an operational procedure, and to generate an operational signal according to the operational procedure. The wireless expanding interface 120 is configured to transmit the operational signal to the function expanding device 130, and the function expanding device 130 includes a displayer 132. When the displayer 132 receives the operational signal via the wireless expanding interface 130 the displayer 132 is configured to display an operational interface of the operational procedure. For example, the displayer 132 can be a liquid-crystal display (LCD), a light-emitting diode (LED) displayer, a projector or any other device which can be configured to display images. With respect to a displayer of the electronic device 110, the displayer 132 has bigger size. Accordingly, when the displayer 132 is configured to display the operational interface of the operational procedure of the electronic device 110, a user can comfortably execute the operational procedure of the electronic device (such as, looking up data or watching videos) via the displayer 132 with the bigger size, so that the quality of user experience is effectively enhanced.

In one embodiment, the function expanding device 130 further includes an input device 134. The input device 134 is configured to generate an input signal, and to transmit the input signal to the electronic device 110 via the wireless expanding interface 120. For example, the input device 134 can be a keyboard, a mouse, a touch panel or any other device which can be configured to execute data input. With respect to an input device of the electronic device 110, the input device 134 has an operational interface with bigger size and an ergonomic interface. Accordingly, a user can comfortably input data to the electronic device 110 via the input device 13, so that the quality of user experience is effectively enhanced.

In one embodiment, the function expanding device 130 further includes an output device 136. The output device 136 is configured to receive the operational signal via the wireless expanding interface 120, and to generate an output signal according to the operational signal. For example, the output device 136 can be a universal serial bus interface (such as, USB·USB 3.0 or USB type C), a display port interface (such as, HDMI or D-sub), a speaker, an external storage device or any other device which can be configured to expand function applications of the electronic device 110. With respect to an output device of the electronic device 110, the output device 136 can support further kinds of output specifications and provide further kinds of function applications. Accordingly, a user can execute various kinds of function applications by using the output device 136 to support the electronic device 110a, so that the quality of user experience is effectively enhanced.

In one embodiment, the function expanding device 130 further comprises a computer device 138. The computer device 138 is configured to execute an operational procedure of the computer device 138, and to transmit an operational signal of the computer device 138 to the electronic device 110 according to the operational procedure of the computer device 138 via the wireless expanding interface 120. In another embodiment, after the electronic device 110 receives the operational signal of the computer device 138 via the wireless expanding interface 120, the electronic device 110 is configured to display an operational interface of the operational procedure of the computer device 138. For example, the computer device 138 can be a desktop computer, a laptop computer, a tablet computer or any other computer device which can be configured to execute data process. When a user has to share the operational interface of the operational procedure of the computer device 138 with other users for watching the operational interface, the user can transmit the operational signal of the computer device 138 to the electronic device 110 via the wireless expanding interface 120. Accordingly, the other users can simultaneously watch the operational interface of the operational procedure of the computer device 138 via a displayer of the electronic device 110, so that the quality of user experience is effectively enhanced.

In one embodiment, the function expanding device 130 includes a battery unit, and the battery unit is configured to provide energy for the function expanding device 130. For example, since the battery unit is disposed in the function expanding device 130, the function expanding device 130 can be used as a mobile expanding device accordingly, so that portability of the function expanding device 130 is dramatically enhanced. In another embodiment, the battery unit can be configured to provide energy for the electronic device 110. For example, the function expanding device 130 having the battery unit can be used as a power bank to charge the electronic device 110 for extending operational time of the electronic device 110, so that the quality of user experience is effectively enhanced.

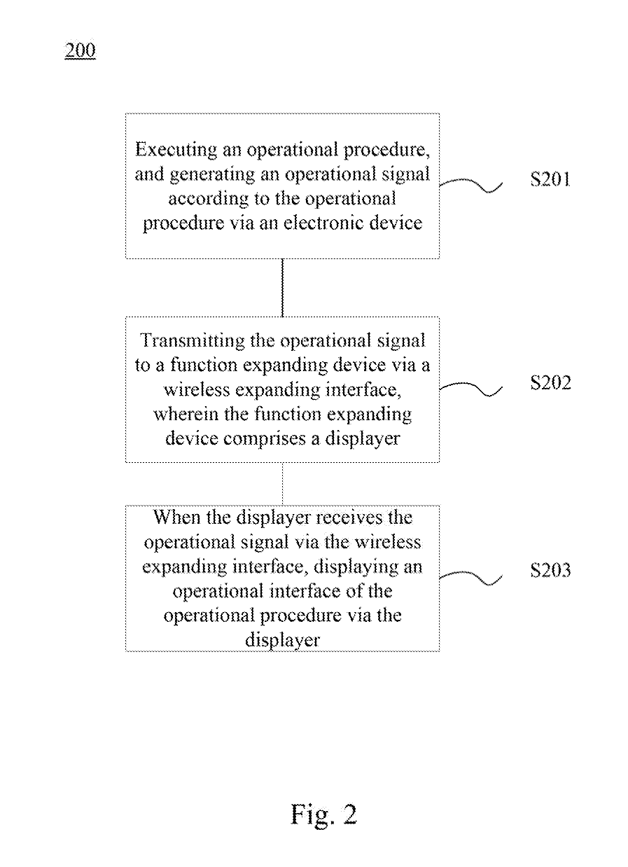

FIG. 2 is a flow chart of a wireless expanding method 200 according to embodiments of the present disclosure. In one embodiment, the wireless expanding method 200 can be implemented by the wireless expanding system 100 mentioned above, but the present disclosure is not limited thereto. For facilitating the understanding of the wireless expanding method 200, the wireless expanding system 100 is used as an example for illustrating the wireless expanding method 200 as follows. As shown in FIG. 2, the wireless expanding method 200 includes operations as follows:
S201: executing an operational procedure, and generating an operational signal according to the operational procedure via the electronic device 110;
S202: transmitting the operational signal to a function expanding device 130 via the wireless expanding interface 120, and the function expanding device 130 includes a displayer 132; and
S203: when the displayer 132 receives the operational signal via the wireless expanding interface 120 displaying an operational of the operational procedure interface via the displayer 132.

For example, with respect to a displayer of the electronic device 110, the displayer 132 has bigger'size. Accordingly, when it is displaying, the operational interface of the operational procedure via the displayer 132, a user can comfortably execute the operational procedure of the electronic device 110 (such as, looking up data or watching videos) via the displayer 132 with the bigger size, so that the quality of user experience is effectively enhanced.

In one embodiment, the function expanding device 130 further includes the input device 134, and the wireless expanding method 200 further includes operations as follows: generating the input signal via the input device 134, and transmitting the input signal to the electronic device 110 via the wireless expanding interface 120. For example, with respect to an input device of the electronic device 110, the input device 134 has an operational interface with bigger size and an ergonomic interface. Accordingly, a user can comfortably input data to the electronic device 110 via the input device 13, so that the quality of user experience is effectively enhanced.

In one embodiment, the function expanding device 130 further includes the output device 136, and the wireless expanding method 200 further includes operations as follows: receiving the operational signal via the wireless expanding interface 120, and generating the output signal according to the operational signal via the output device 136. For example, with respect to an output device of the electronic device 110, the output device 136 can support further kinds of output specifications and provide further kinds of function applications. Accordingly, a user can execute various kinds of function applications by using the output device 136 to support the electronic device 110 to, so that the quality of user experience is effectively enhanced.

In one embodiment, the function expanding device 130 further includes the computer device 138, and the wireless expanding method 200 further includes operations as follows: executing the operational procedure of the computer device 138 via the computer device 138, and transmitting the operational signal of the computer device 138 to the electronic device 110 according to the operational procedure of the computer device 138 via the wireless expanding interface 120. In another embodiment, after the electronic device 110 receives the operational signal of the computer device 138 via the wireless expanding interface 120, it is displaying the operational interface of the operational procedure of the computer device 138 via the electronic device 110. For example, when a user has to share the operational interface of the operational procedure of the computer device 138 with other users for watching the operational interface, the user can transmit the operational signal of the computer device 138 to the electronic device 110 via the wireless expanding interface 120. Accordingly, the other users can simultaneously watch the operational interface of the operational procedure of the computer device 138 via a displayer of the electronic device 110, so that the quality of user experience is effectively enhanced.

In the embodiments mentioned above, the wireless expanding system and the wireless expanding method disclosed in the present disclosure connect the electronic device with the function expanding devices via the wireless expanding interface, so that the function expanding devices (such as, a displayer) can support various kinds of function applications of the electronic device. For example, when the electronic device is connected to the displayer with bigger size via the wireless expanding interface, the displayer can be configured to display the operational interface of the operational procedure of the electronic device. Accordingly a user can comfortably execute the operational procedure of the electronic device via the displayer with the bigger size. In other word, since the various kinds of function applications of the electronic device can be support by the different function expanding devices, the wireless expanding system and the wireless expanding method disclosed in the present disclosure can not only effectively remain the portability of the electronic device, but also enhance the quality of user experience.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present invention cover modifications and variations of this present disclosure provided they fall within the scope of the following claims.

What is claimed is:

1. A wireless expanding system, comprising:
an electronic device configured to execute an operational procedure, and to generate an operational signal according to the operational procedure; and
a wireless expanding interface, connected to the electronic device, and configured to transmit the operational signal to a function expanding device, wherein the function expanding device comprises a displayer, when the displayer receives the operational signal via the wireless expanding interface, the displayer is configured to display an operational interface of the operational procedure.

2. The wireless expanding system of claim 1, wherein the function expanding device further comprises an input device, the input device is configured to generate an input signal, and to transmit the input signal to the electronic device via the wireless expanding interface.

3. The wireless expanding system of claim 1, wherein the function expanding device further comprises an output device, the output device is configured to receive the operational signal via the wireless expanding interface, and to generate an output signal according to the operational signal.

4. The wireless expanding system of claim 1, wherein the function expanding device further comprises a computer device, the computer device is configured to execute an operational procedure of the computer device, and to transmit an operational signal of the computer device to the electronic device according to the operational procedure of the computer device via the wireless expanding interface.

5. The wireless expanding system of claim 4, wherein after the electronic device receives the operational signal of the computer device via the wireless expanding interface, the electronic device is configured to display an operational interface of the operational procedure of the computer device.

6. A wireless expanding method, comprising:
executing an operational procedure, and generating an operational signal according to the operational procedure via an electronic device;
transmitting the operational signal to a function expanding device via a wireless expanding interface, wherein the function expanding device comprises a displayer; and
when the displayer receives the operational signal via the wireless expanding interface, displaying an operational interface of the operational procedure via the displayer.

7. The wireless expanding method of claim 6, wherein the function expanding device further comprises an input device, and the wireless expanding method further comprises:
generating an input signal via the input device, and transmitting the input signal to the electronic device via the wireless expanding interface.

8. The wireless expanding method of claim 6, wherein the function expanding device further comprises an output device, and the wireless expanding method comprises:
receiving the operational signal via the wireless expanding interface, and generating an output signal according to the operational signal via the output device.

9. The wireless expanding method of claim 6, wherein the function expanding device further comprises a computer device, and the wireless expanding method further comprises:
executing an operational procedure of the computer device via the computer device, and transmitting an operational signal of the computer device to the electronic device according to the operational procedure of the computer device via the wireless expanding interface.

10. The wireless expanding method of claim 9, wherein after the electronic device receives the operational signal of the computer device via the wireless expanding interface, displaying an operational interface of the operational procedure of the computer device via the electronic device.
